(19) United States
(12) Patent Application Publication
(10) Pub. No.: US 2026/0169657 A1
(43) Pub. Date: Jun. 18, 2026

(54) MEMORY CONTROLLER PROCESSING MASKED WRITE COMMAND, OPERATING METHOD OF THE MEMORY CONTROLLER, AND MEMORY SYSTEM

(71) Applicant: SAMSUNG ELECTRONICS CO., LTD., Suwon-si (KR)

(72) Inventors: Hyowon An, Suwon-si (KR); Jooyong Park, Suwon-si (KR); Wonjun Moon, Suwon-si (KR)

(73) Assignee: SAMSUNG ELECTRONICS CO., LTD., Suwon-si (KR)

(21) Appl. No.: 19/395,585

(22) Filed: Nov. 20, 2025

(30) Foreign Application Priority Data
Dec. 12, 2024 (KR) 10-2024-0185074

(51) Int. Cl. G06F 3/06

(52) U.S. Cl. CPC G06F 3/0659; G06F 3/0611; G06F 3/0656; G06F 3/0673

(57) ABSTRACT

An operating method of a memory controller includes receiving, from a host, a masked write request, generating a dummy read command for a target address of the masked write request, converting the masked write request into a normal write command, based on processing of the dummy read command, and performing the normal write command.

### CROSS-REFERENCE TO RELATED APPLICATIONS

This application claims priority under 35 U.S.C. § 119 to Korean Patent Application No. 10-2024-0185074, filed on Dec. 12, 2024, in the Korean Intellectual Property Office, the disclosure of which is incorporated by reference herein in its entirety.

### BACKGROUND

### 1. Field

The present disclosure relates generally to a memory controller, and more particularly, to a memory controller for processing a masked write command, an operating method thereof, and a memory system.

### 2. Description of Related Art

A masked write operation may operate as a read-modify-write (RMW) process For example, the masked write operation may necessitate a command to command delay for masked write (tCCDMW). However, the tCCDMW delay may be longer than a command to command delay (tCCD) that may be included in a normal write command. For example, the tCCDMW delay may be up to four times longer than the tCCD delay. Consequently, a tCCDMW time penalty incurred by the masked write operation may contribute to an increase of a maximum latency at a system level of a related memory system, which may be critical in a system composed of real-time intellectual properties (IPs).

To potentially address this time penalty, related dynamic random access memory (DRAM) schedulers may prioritize masked write commands to potentially prevent bubbles in DRAM utilization when the last remaining commands in the write queue are masked write commands, which may result in potentially higher efficiency when compared to general scheduling. However, when a relatively large number of masked write commands occupy a specific bank, a maximum latency of that bank may increase, which may not be addressed by the prioritized scheduled of the related DRAM schedulers.

Thus, there exists a need for further improvements in memory controller technology, as the need for performing masked write operations may be constrained by maximum latency increases. Improvements are presented herein. These improvements may also be applicable to other semiconductor technologies.

### SUMMARY

One or more example embodiments of the present disclosure provide a memory controller, an operating method thereof, and a memory system, which are capable of minimizing a command to command delay for masked write (tCCDMW) penalty of a masked write command by converting a masked write command into a dummy read command and a normal write command and performing the converted commands.

According to an aspect of the present disclosure, an operating method of a memory controller includes receiving, from a host, a masked write request, generating a dummy read command for a target address of the masked write request, converting the masked write request into a normal write command, based on processing of the dummy read command, and performing the normal write command.

According to an aspect of the present disclosure, a memory controller includes a buffer memory, one or more processors including processing circuitry, and memory storing instructions. The instructions, when executed by the one or more processors individually or collectively, cause the memory controller to receive, from a host, a masked write request, generate a dummy read command for a target address of the masked write request, and convert the masked write request into a normal write command, based on processing of the dummy read command.

According to an aspect of the present disclosure, a memory system includes a host device configured to generate a masked write request including masked write data and mask bits indicating a mask region, and a memory device including a memory controller including one or more dynamic random access memories (DRAMs), one or more buffer memories, and a scheduler. The memory controller is configured to receive, from the host device, the masked write request, generate a dummy read command for a target address of the masked write request, and convert the masked write request into a normal write command, based on processing of the dummy read command.

Additional aspects may be set forth in part in the description which follows and, in part, may be apparent from the description, and/or may be learned by practice of the presented embodiments.

### BRIEF DESCRIPTION OF DRAWINGS

The above and other aspects, features, and advantages of certain embodiments of the present disclosure may be more apparent from the following description taken in conjunction with the accompanying drawings, in which:

FIG. 1 is a diagram illustrating a memory system including a memory device performing a masked write operation, according to an embodiment;

FIG. 2 is a block diagram of a memory device, according to an embodiment;

FIG. 3A illustrates a scheduler, according to a comparative example;

FIG. 3B illustrates a scheduler, according to an embodiment;

FIG. 4 is a flowchart illustrating an operating method of a scheduler, according to an embodiment;

FIG. 5A illustrates changes in a command queue, according to an embodiment;

FIG. 5B illustrates an example of a buffer state, according to an embodiment;

FIG. 6 is a flowchart illustrating an operating method of a scheduler, according to an embodiment;

FIG. 7 illustrates a command processing sequence, according to a comparative example;

FIG. 8 illustrates a command processing sequence, according to an embodiment; and

FIG. 9 is a block diagram of a system with an electronic device including the memory device, according to embodiments.

FIG. 10 is a block diagram of a memory controller, according to embodiments; and

FIG. 11 is a block diagram of a memory system, according to embodiments.

### DETAILED DESCRIPTION

Hereinafter, various embodiments are described with reference to the attached drawings. The embodiments are provided to describe the present disclosure to a person having ordinary skill in the art. The embodiments may have various modifications and forms, and specific embodiments thereof are illustrated in the drawings and described in detail. However, the embodiments are not intended to limit the present disclosure to particular modes of practice, and it is to be understood to include all modifications, equivalents, or substitutes included in the spirit and technical scope of the present disclosure. When describing each drawing, similar reference numerals are used to refer to similar components. In the attached drawings, the dimensions of the structures may be illustrated enlarged or reduced from the actual size to ensure clarity of the embodiments.

The terminology used in the present disclosure is used only to describe particular embodiments and is not intended to limit the present disclosure. Singular expressions include plural expressions unless the context clearly indicates otherwise. In the present disclosure, it is to be understood that terms such as “include” or “have” are intended to specify the presence of a feature, number, step, operation, component, part, or combination thereof described in the disclosure, but may not exclude in advance the possibility of the presence or addition of one or more other features, numbers, steps, operations, components, parts, or combinations thereof.

Unless otherwise defined, all terms used herein, including technical and scientific terms, have the same meaning as commonly understood by those of ordinary skill in the art to which the embodiments pertain. Terms defined in commonly used dictionaries should be interpreted as having a meaning consistent with their meaning in the context of the relevant art, and may not be interpreted in an idealized and/or overly formal sense unless expressly defined in the present disclosure.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

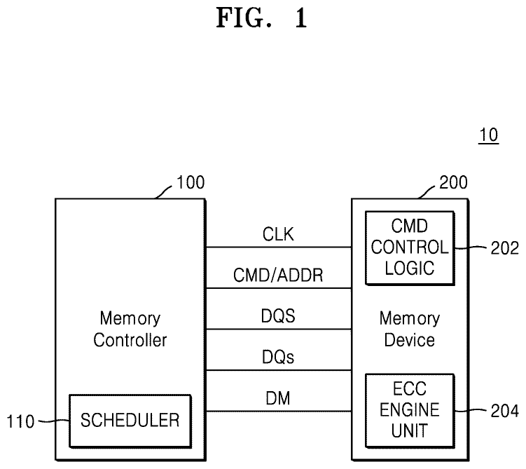

FIG. 1 is a diagram illustrating a memory system including a memory device performing a masked write operation, according to an embodiment.

Referring to FIG. 1, the memory system 10 may include a memory controller 100 and a memory device 200. The memory controller 100 may control the memory device 200. The memory controller 100 may transmit control signals such as, but not limited to, a clock signal CLK, a command signal CMD, an address signal ADDR, a data strobe signal DQS, a data mask signal DM, and data signals DQs to the memory device 200, and/or may receive the data strobe signal DQS and data signals DQs from the memory device 200. The memory controller 100 may issue a read command READ, a write command WRITE, and a masked write command MWR and may transmit the commands to the memory device 200.

The memory device 200 may include a command (CMD) control logic component 202 and an error correction code (ECC) engine component 204. The command control logic component 202 may receive the command CMD issued by the memory controller 100 and may generate an internal command INT_CMD that may control the operation of the memory device 200, according to the command CMD.

The memory device 200 may perform a read operation in response to the read command READ, a write operation in response to the write command WRITE, and a masked write operation in response to the masked write command MWR. The masked write operation may include masking data from being written to a portion of a memory cell block that may constitute a memory cell array during the write operation.

The command control logic component 202 may generate an internal read command INT_RD and an internal write command INT_WR, according to a read command READ, a write command WRITE, or a masked write command MWR of the memory controller 100. According to the internal read command INT_RD and the internal write command INT_WR, the read operation, the write operation, and the masked write operation of the memory device 200 may be performed.

According to an embodiment, the memory controller 100 may include a scheduler 110. The scheduler 110 may manage read requests and/or write requests as access management for the memory device 200. For example, the scheduler 110 may buffer read requests and/or write requests in a scheduling queue and process the requests in sequence. The scheduler 110 may control the memory device 200 by converting each request into a dynamic random access memory (DRAM) command sequence, according to the processing order of the scheduling queue.

According to an embodiment, the scheduler 110 may convert the masked write request. For example, when the masked write request is received, the scheduler 110 may convert the masked write request into the dummy read command and the normal write command instead of generating the masked write command. Since a command-to-command delay for masked write (tCCDMW) of the masked write command may be significantly longer (e.g., four times greater) than a command-to-command delay (tCCD) of a normal write command and/or read command, the scheduler 110 may add a dummy read command and a normal write command to the scheduling queue instead of the masked write command to potentially improve (e.g., reduce) a maximum latency of the memory system 10.

In an embodiment, the scheduler 110 may be physically implemented by analog and/or digital circuits including one or more of a logic gate, an integrated circuit, a microprocessor, a microcontroller, a memory circuit, a passive electronic component, an active electronic component, an optical component, and the like. For example, a field programmable gate array (FPGA) may be used to implement custom logic that may include the functionality of the scheduler 110. As another example, a processor in combination with a memory may be used to execute one or more instructions to perform the functionality of the scheduler 110. Alternatively or additionally, at least a portion of the functionality of the scheduler 110 may be incorporated into the memory controller 100 and/or implemented as instructions to be executed by the memory controller 100.

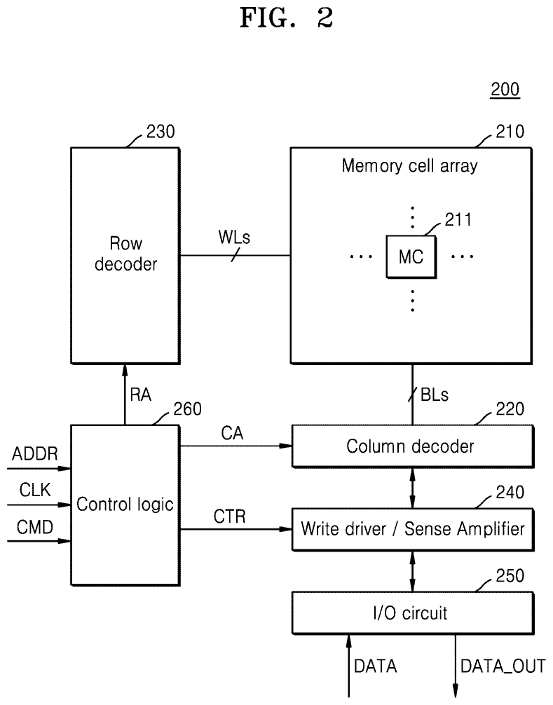

FIG. 2 is a block diagram of a memory device, according to an embodiment.

Referring to FIG. 2, the memory device 200 may receive a command CMD, an address ADDR, a clock CLK, and input data DATA_IN. For example, the memory device 200 may receive the command CMD instructing a write operation, the address ADDR, and input data DATA_IN, and store the input data DATA_IN in a memory cell area corresponding to the address ADDR in a memory cell array 210. As another example, the memory device 200 may receive the read command CMD instructing a read operation and the address ADDR, read data stored in the memory cell area corresponding to the address ADDR, and output the read data externally as output data DATA_OUT.

In an embodiment, the memory device 200 may include the memory cell array 210, a column decoder 220, a row decoder 230, a write driver/sense amplifier 240, an input/output circuit 250, and control logic 260.

The memory cell array 210 may include a plurality of memory cells MC 211. The plurality of memory cells MC 211 may be placed at points where word lines WLs and bit lines BLs intersect. The column decoder 220 may select at least one bit line from among a plurality of bit lines BLs based on a column address CA. The row decoder 230 may activate at least one word line from among a plurality of word lines WLs based on a row address RA. That is, the row decoder 230 may select at least one word line from among the plurality of word lines WLs.

The write driver/sense amplifier 240 may transmit input data DATA_IN received from the input/output circuit 250 to the column decoder 220 during the write operation. Alternatively or additionally, the write driver/sense amplifier 240 may amplify data received from the column decoder 220 during the read operation and transmit output data DATA_OUT to the input/output circuit 250. The input/output circuit 250 may deliver the input data DATA_IN to the write driver/sense amplifier 240. Alternatively or additionally, the input/output circuit 250 may output the output data DATA_OUT transmitted from the write driver/sense amplifier 240.

The control logic 260 may receive a command CMD, an address ADDR, and a clock CLK, and may generate a row address RA, a column address CA, and a control signal CTR. For example, the control logic 260 may identify a read command by decoding a command CMD and generate a row address RA, a column address CA, and a control signal CTR to read output data DATA_OUT from the memory cell array 210. As another example, the control logic 260 may identify a read command by decoding a command CMD and generate a row address RA, a column address CA, and a control signal CTR to read output data DATA_OUT from the memory cell array 210.

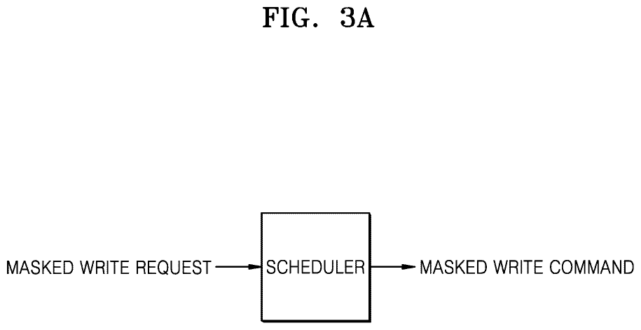

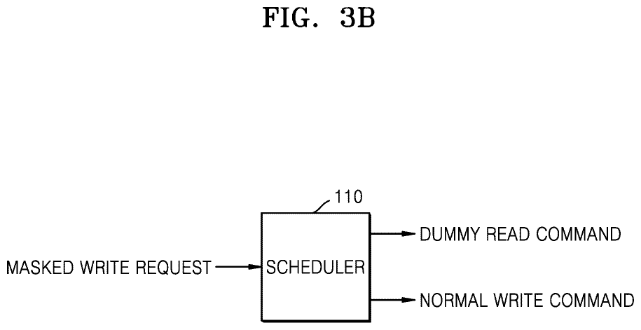

FIG. 3A illustrates a scheduler, according to a comparative example. FIG. 3B illustrates the scheduler 110, according to an embodiment.

Referring to FIG. 3A, the scheduler, according to a comparative example, may receive a masked write request. For example, a host may request the write operation for only a portion of the data within the access unit size of a DRAM. The scheduler may receive the masked write request that requests the write operation while masking the remaining data, except for the portion of the data for which a write is requested within an access unit of the DRAM. In response to receiving the masked write request, the scheduler may transmit a masked write command to the memory device (e.g., the memory device 200 in FIG. 1). The masked write command may include write data to be written in a page of the target address and mask data indicating the data that is not to be written.

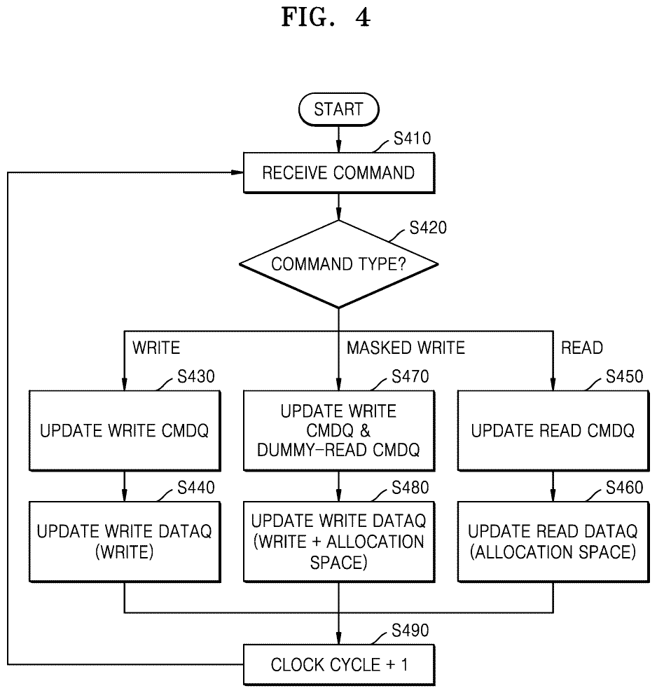

Referring to FIG. 3B, a scheduler, according to an embodiment, may receive a masked write request. The scheduler 110 may bypass (prevent) the generation of a masked write command in response to the masked write request. Instead, the scheduler 110 may generate a dummy read command and a normal write command in response to the masked write request. For example, the scheduler 110 may add a dummy read command to the scheduling queue. The dummy read command may be and/or may include a command to convert the masked write command into a normal write command. For example, the target address of the dummy read command may be the same as the target address of the masked write request. The scheduler 110 may read the page of the target address of the masked write command through the dummy read command and write only the masked region of the read page into a write buffer. As the masked write data has already been written into the write buffer, according to the masked write request, by writing the masked region of the read page into the write buffer, the data stored in the write buffer may be matched with the size of the write data of a general write command. That is, the masked write command may be converted into a normal write command by reading data from the mask region through the dummy read command and writing the read data into the write buffer. After the bus direction is turned around and the write phase is entered, the scheduler 110 may transmit a normal write command to the memory device 200, as described with reference to FIG. 4.

FIG. 4 is a flowchart illustrating an operating method of the scheduler 110, according to an embodiment.

Referring to FIG. 4, in operation S410, the scheduler 110 receive a request REQ as the command CMD and may identify the request type in operation S420. For example, the request REQ may be any one of a masked write request, a normal write request, or a read request. However, embodiments of the present disclosure at not limited thereto, and the request REQ may be and/or may include other request types.

In operation S430, the scheduler 110 may update a write command queue. For example, the scheduler 110 may have identified that the request is a normal write request. In this case, the scheduler 110 may update the write command queue by adding a write command to the write command queue in response to the normal write request.

In operation S440, the scheduler 110 may update the write data queue. For example, the scheduler 110 may add write data to the write data queue in response to an update of the write command queue.

In operation S450, the scheduler 110 may update a read command queue. For example, the scheduler 110 may have identified that the request is a read request. In this case, the scheduler 110 may update the read command queue by adding a read command to the read command queue in response to the read request.

In operation S460, the scheduler 110 may update a read data queue. For example, the scheduler 110 may allocate a region to store read data to be transmitted from the memory device 200 in the future in response to an update of the read command queue.

In operation S470, the scheduler 110 may update the write command queue and the read command queue together. For example, the scheduler 110 may identify that the request is a masked write request based on a mask bit. In this case, the scheduler 110 may add a dummy read command to the read command queue in response to the masked write request. The dummy read command may refer to a command for converting the masked write command into a normal write command.

In operation S480, the scheduler 110 may update the write data queue. The scheduler 110 may allocate a buffer region assuming a normal write as the request is identified as the masked write request. For example, a data bandwidth of DRAM may be 64 bytes and a masked write data may be 8 bytes. The scheduler 110 may request buffer allocation for write data not only in a size corresponding to the masked write data (e.g., 8 bytes), but also in a size corresponding to the entire data bandwidth (e.g., 64 bytes). The scheduler 110 may write only the masked write data into the allocated buffer while ensuring that the masked region remains. Thereafter, the scheduler 110 may read the target address page of the masked write command to acquire the data in the mask region. This operation may be intended to enable access, according to the normal write command of the data bandwidth, by adding the data from the mask region to the masked write data that may have already been written to the buffer.

In operation S490, the scheduler 110 may repeat the operation from operation S410 in the next cycle by incrementing the clock cycle.

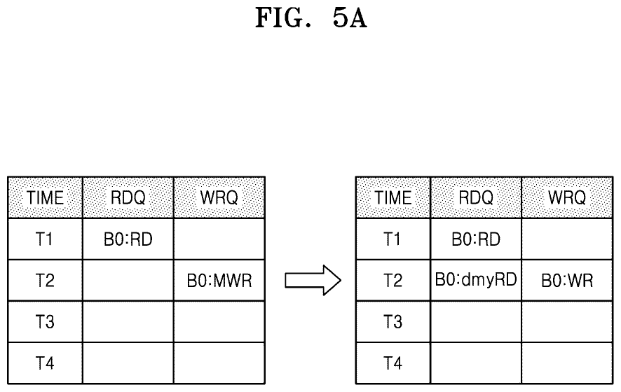

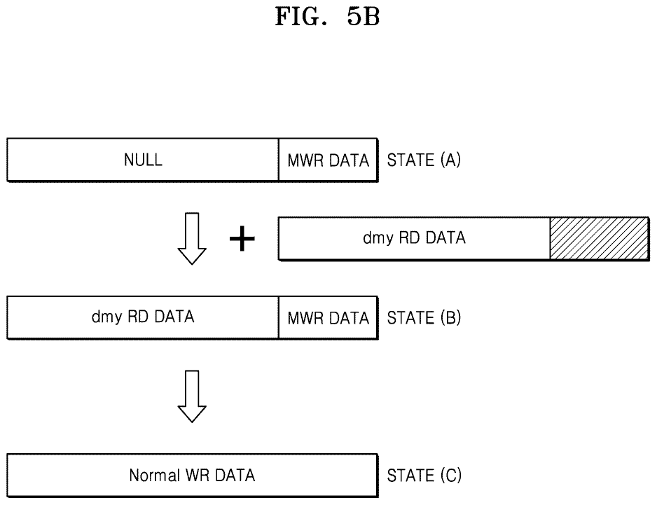

FIG. 5A illustrates changes in a command queue, according to an embodiment.

Referring to FIG. 5A, a read command queue RDQ and a write command queue WRQ are illustrated in chronological order.

At a first time T1, a read request for bank 0 B0 may be received. The scheduler 110 may add a read command RD for bank 0 B0 to the read command queue RDQ in response to the read request.

At a second time T2, a masked write request for bank 0 B0 may be received. The scheduler 110 may add the masked write command MWR to the write command queue WRQ in response to the masked write request.

Thereafter, the scheduler 110 may convert the masked write command MWR to reduce the penalty of tCCDMW of the masked write command, according to an embodiment. For example, the scheduler 110 may generate a dummy read command dmyRD for bank 0 B0 and add the dummy read command dmyRD to a read command queue RDQ. The scheduler 110 may generate a normal write command WR for bank 0 B0 and add the normal write command WR to a write command queue WRQ.

FIG. 5B illustrates an example of a buffer state, according to an embodiment.

Referring to FIG. 5B, state (A) may correspond to the point in time when the scheduler 110 receives the masked write request (e.g., second time T2 of FIG. 5A). For example, the scheduler 110 may request allocation of the buffer region to store the masked write data, according to the masked write request. The scheduler 110 may request allocation of the buffer region equal to (or corresponding to) the size of the data bandwidth, rather than requesting allocation of the buffer region equal to the size of the masked write data. Therefore, in the state (A), the mask region may correspond to NULL, and the remaining region may be written with masked write data MWR DATA.

State (B) may correspond to the point in time when the scheduler 110 completes the dummy read command (e.g., second time T2 of FIG. 5A). The scheduler 110 may perform the dummy read command on the target address page of the masked write request. That is, the page to which the masked write data is to be written may first be read and stored in the buffer. The scheduler 110 may write only the data corresponding to the mask region into the buffer from the read page. Therefore, in the state (B), the mask region may be filled with the data (dmy RD DATA) read through the dummy read command.

State (C) may be the point in time when the scheduler 110 converts the masked write command into the normal write command (e.g., third time T3 of FIG. 5A). That is, the scheduler 110 may treat the dummy read data (dmy RD DATA) of the mask region and the masked write data (MWR DATA) of the non-mask region as the write data of the general write command. The scheduler 110 may write the write data to the page of the target address, according to the converted normal write command.

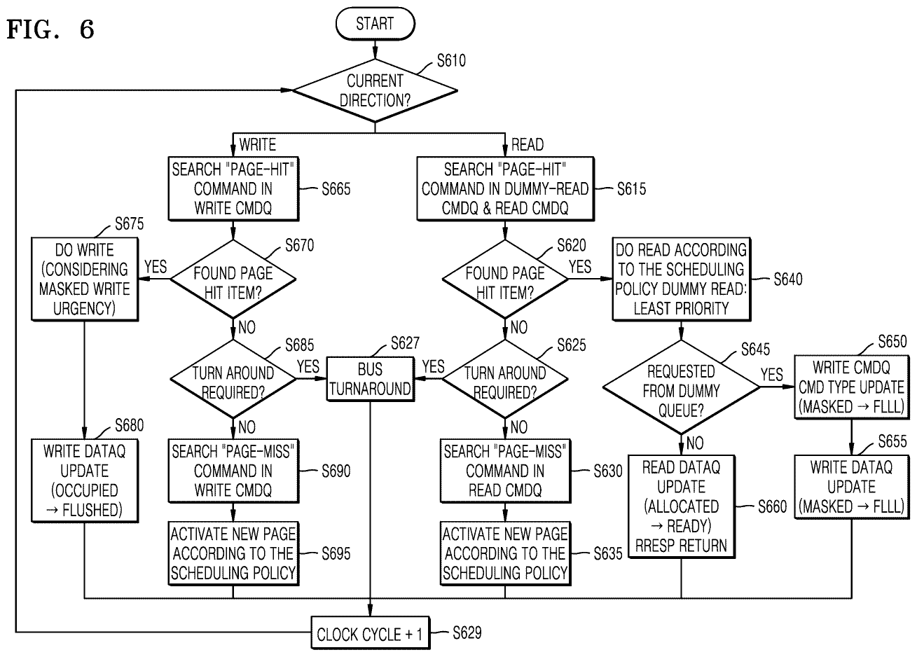

FIG. 6 is a flowchart illustrating an operating method of the scheduler 110, according to an embodiment.

Referring to FIG. 6, the scheduler 110 may identify the transmission direction of the current data bus in operation S610. For example, in the case of a read phase, the transmission direction of the data bus may be from the memory device 200 to the memory controller 100. As another example, in the case of a write phase, the transmission direction of the data bus may be from the memory controller 100 to the memory device 200. Hereinafter, the phase in FIG. 6 may be assumed to be the read phase (READ in operation S610). In operation S610, in the case of the write phase where the data bus transfer direction is heading from the memory controller 100 to the memory device 200, the process may proceed to operation S665 (WRITE in operation S610).

In operation S615, the scheduler 110 may search for the read command queue RDQ to determine whether a page hit occurs. The page hit may refer to a condition where the currently open page matches the page of the target address. That is, the scheduler 110 may search whether the page hit occurs based on a page table entry (PTE). For example, when page 1 of bank 0 is open, the valid value of bank 0, page 1 from among the PTEs may be one (1). The scheduler 110 may search for the page hit by comparing whether the target addresses of commands waiting in the read command queue RDQ are the same as the addresses in which the valid value of the PTE is one (1). However, embodiments of the present disclosure are not limited thereto, and the value of the PTE that may indicate that a page hit has occurred may be another value other than one (1).

In operation S620, the scheduler 110 may determine whether there is an item in which a page hit has occurred. If there is no match between the target address of a command waiting in the read command queue RDQ and a page in which the valid value of the PTE is one (1), the scheduler 110 may determine that there is no page hit item (NO in operation S620). If there are no page hit items, operation S625 may proceed.

In operation S625, the scheduler 110 may determine whether a turnaround is necessary. The turnaround may refer to a change in the direction of the data bus. For example, the scheduler 110 may determine whether the turnaround is necessary based on various conditions including but not limited to, whether an urgent write command is requested and/or whether the read phase enters after a threshold time. If a turnaround is required (YES in operation S625), in operation S627, the scheduler 110 may turn around the data bus direction and repeat the operation from S610 in the next cycle by incrementing the clock cycle in operation S629. According to an embodiment, if no turnaround is required (NO in operation S625), the process may proceed to operation S630.

In operation S630, the scheduler 110 may determine whether a page miss has occurred. The page miss may refer to a mismatch between the currently open page and the page at the target address. For example, the scheduler 110 may search whether a page miss occurs based on the PTE. For example, if page 1 of bank 0 is open, the valid value of bank 0, page 1 from among PTEs may be one (1). The scheduler 110 may search for a page miss by comparing whether the target addresses of commands waiting in the read command queue RDQ are different from the addresses in which the valid value of the PTE is one (1). If there is no match between the target address of a command waiting in the read command queue RDQ and a page in which the valid value of the PTE is one (1), the scheduler 110 may determine that there is a page miss. However, embodiments of the present disclosure are not limited thereto, and the value of the PTE that may indicate that a page miss has occurred may be another value other than one (1).

In operation S635, the scheduler 110 may activate a new page, according to the scheduling policy. That is, since the currently open page does not match the target address in operation S630, the open page may be closed, and a new page may be activated and opened. Thereafter, the scheduler 110 may repeatedly perform operation S610 in the next cycle.

In operation S640, the scheduler 110 may perform data read, according to the scheduling policy. Since a page hit item was detected in operation S620, the scheduler 110 may perform the read command or the dummy read command, according to the scheduling policy. The priority of the dummy read command may be lower than that of the (normal) read command. This scheduling policy may potentially reduce bubbles in tCCDMW by processing a plurality of consecutive masked write requests by setting the dummy read command to a lower priority than the read command.

In operation S645, the scheduler 110 may determine whether the data read corresponds to the dummy read command. For example, the data read in operation S640 may be data according to the dummy read command. When the data is read through the dummy read command, determining whether the data read corresponds to the dummy read command may be needed because the mask region of the data may be stored in the buffer. When the data is read, according to the (normal) read command, the read data queue may be updated by proceeding to operation S660. Thereafter, the scheduler 110 may repeatedly perform operation S610 in the next cycle.

In operation S650, the scheduler 110 may convert the masked write command into the normal write command. For example, when the data read in operation S645 corresponds to the dummy read command, the masked write command waiting in the write command queue may be converted into the normal write command.

In operation S655, the scheduler 110 may update the write data queue. That is, the scheduler 110 may write data (e.g., dmy RD DATA in the state (B) in FIG. 5B) corresponding to the mask region of the data read in operation S640 into the buffer. Additionally, when the masked write command is input to the buffer, the masked write data (e.g., MWR DATA in the state (A) in FIG. 5B) may have already been written to the non-mask region. The scheduler 110 may additionally merge the dummy read data dmy RD DATA corresponding to the mask region into the masked write data MWR DATA previously stored in the buffer and set the merged masked write data as write data for the normal write command. Thereafter, the scheduler 110 may repeatedly perform operation S610 in the next cycle. According to various embodiments, when the data bus turns around from the read phase to the write phase, the scheduler 110 may write the write data of the write data queue, which may have been updated in operation S655, according to the normal write command, to the memory device 200. For example, the write data may be data in which dummy read data dmy RD DATA corresponding to the mask region may be additionally merged into the masked write data MWR DATA that may have been previously stored in the buffer. That is, the masked write command, which has a tCCDMW penalty, may not be directly processed but instead may be converted into a dummy read command and a normal write command, each having only a tCCD latency, thereby enabling the same data to be written to the memory device 200.

In operation S665, the scheduler 110 may search for whether a page hit occurs in the write command queue WRQ. The page hit may refer to a condition where the currently open page matches the page of the target address. For example, the scheduler 110 may search for whether a page hit occurs based on the PTE. For example, if page 1 of bank 0 is open, the valid value of bank 0, page 1 among PTEs may be one (1). The scheduler 110 may search for the page hit by comparing whether the target addresses of commands waiting in the write command queue WRQ are the same as the addresses in which the valid value of the PTE is one (1).

In operation S670, the scheduler 110 may determine whether there is an item in which the page hit occurs. If there is no match between the target address of a command waiting in the write command queue WRQ and a page in which the valid value of the PTE is one (1), the scheduler 110 may determine that there is no page hit item. When there is no page hit item, the process may proceed to operation S685.

In operation S685, the scheduler 110 may determine whether a turnaround is needed. The turnaround may refer to a change in the direction of the data bus. For example, the scheduler 110 may determine whether the turnaround is needed, according to various conditions including but not limited to, whether an urgent read command has been requested and/or whether the write phase enters after a threshold time. If a turnaround is required (YES in operation S685), the scheduler 110 may turn around the data bus direction, in operation S627, and repeat the operation from S610 in the next cycle by incrementing the clock cycle in operation S629. According to an embodiment, if no turnaround is required (NO in operation S685), the process may proceed to operation S690.

In operation S690, the scheduler 110 may determine whether a page miss has occurred. The page miss may refer to a mismatch between the currently open page and the page at the target address. For example, the scheduler 110 may search for whether a page miss occurs based on the PTE. For example, if page 1 of bank 0 is open, the valid value of bank 0, page 1 among PTEs may be one (1). The scheduler 110 may search for a page miss by comparing whether the target addresses of commands waiting in the write command queue WRQ are different from the addresses in which the valid value of the PTE is one (1). If there is no match between the target address of a command waiting in the write command queue WRQ and a page in which the valid value of the PTE is one (1), the scheduler 110 may determine that there is a page miss.

In operation S695, the scheduler 110 may activate a new page, according to the scheduling policy. That is, since the currently open page does not match the target address in operation S690, the open page may be closed, and a new page may be activated and opened. Thereafter, the scheduler 110 may repeatedly perform operation S610 in the next cycle.

In operation S675, the scheduler 110 may perform data write, according to the scheduling policy. Since the page hit item was detected in operation S670, the scheduler 110 may perform the write command, according to the scheduling policy. The write data written to the memory device 200, according to the write command, may correspond to the write data of a general write command, or the write data may be write data generated by merging the data dmy RD DATA read through the dummy read command in a previous cycle with the masked write command data MWR DATA, depending on the state (B) in FIG. 5B.

In operation S680, the scheduler 110 may update the write data queue. Since the write data waiting in the write data queue is written in the memory device 200, the corresponding buffer region may be deallocated and flushed.

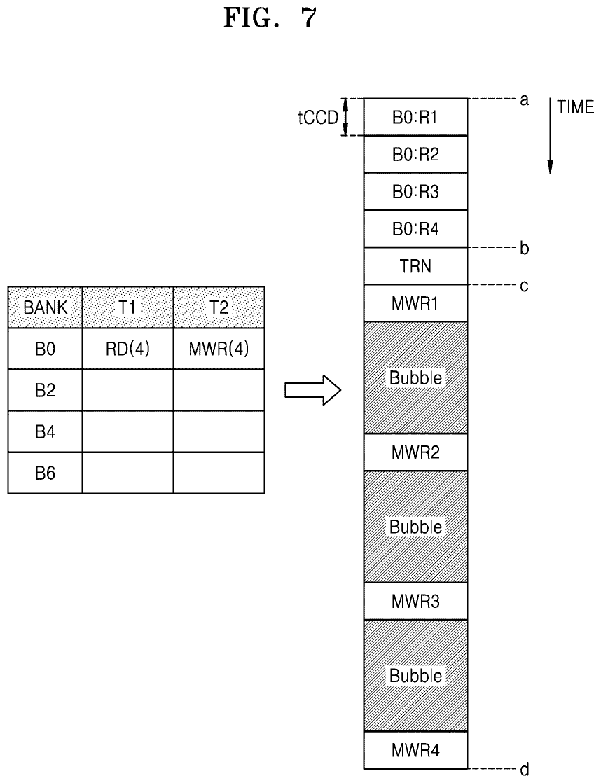

FIG. 7 illustrates a command processing sequence, according to a comparative example.

FIG. 7 illustrates a state where eight (8) commands are pending in the queue for Bank 0 B0. For example, at a first time point T1, there may be four (4) requested read commands RD(4) queued for the bank B0 (e.g., a first read command B0:R1, a second read command B0:R2, a third read command B0:R3, and a fourth read command B0:R4). At a second time point T2, the four (4) masked write commands MRW(4) requested for the bank 0 B0 (e.g., a first masked write command B0:MWR1, a second masked write command B0:MWR2, a third masked write command B0:MWR3, and a fourth masked write command B0:MWR4) may be waiting in the queue.

According to a comparative example, the masked write command may be processed without converting the masked write command into the dummy read command and the normal write command. In such a case, the four (4) read commands (e.g., the first to fourth read commands B0:R1 to B0:R4) requested first from time a to time b may be sequentially performed. At time b, the data bus may be in the read phase. Thereafter, in order to perform the masked write command, the scheduler 110 may need to perform a turnaround TRN to change to the write phase.

According to a comparative example, the four (4) masked write commands (e.g., the first to fourth masked write commands B0:MWR1 to B0:MWR4) may be sequentially performed during time c to time d. However, since the command-command delay of the masked write command tCCDMW is significantly longer (e.g., four (4) times) than the command-to-command delay tCCD of a normal write command, bubbles may be generated between the masked write commands.

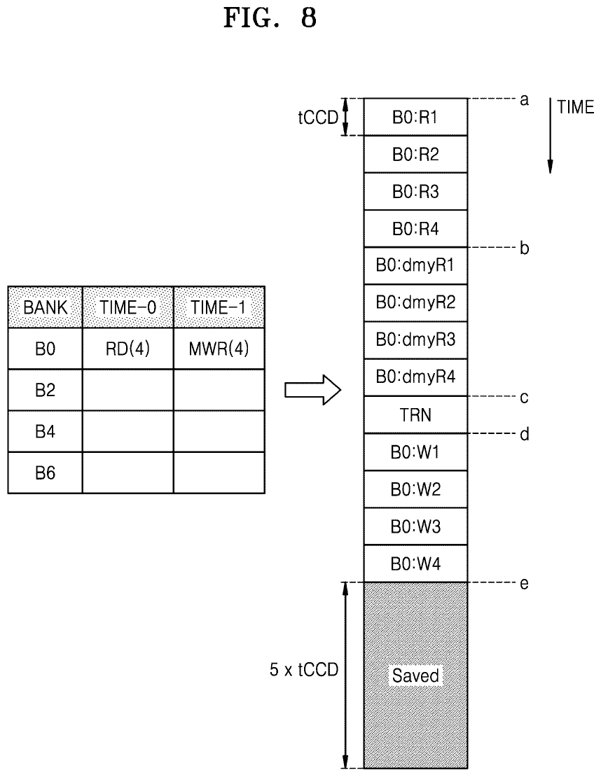

FIG. 8 illustrates a command processing sequence, according to an embodiment.

FIG. 8 illustrates a state in which eight (8) commands are queued and waiting for bank 0 (B0). For example, at the first time point T1, there may be four (4) requested read commands RD(4) queued for the bank 0 (B0) (e.g., a first read command B0:R1, a second read command B0:R2, a third read command B0:R3, and a fourth read command B0:R4). At the second time point T2, the four masked write commands MRW(4) requested for the bank 0 (B0) (e.g., a first masked write command B0:MWR1, a second masked write command B0:MWR2, a third masked write command B0:MWR3, and a fourth masked write command B0:MWR4) may be waiting in the queue.

According to an example, the masked write command may be converted into the dummy read command and the normal write command. Accordingly, four (4) dummy read commands (e.g., a first dummy read command B0:dmyR1, a second dummy read command B0:dmyR2, a third dummy read command B0:dmyR3, and a fourth dummy read command B0:dmyR4) and four (4) normal write commands (e.g., a first normal write command B0:W1, a second normal write command B0:W2, a third normal write command B0:W3, and a fourth normal write command B0:W4) may be added to the scheduling queue.

According to an embodiment, the first to fourth read commands B0:R1 to B0:R4 requested previously may be sequentially performed from time a to time b. Unlike the comparative example of FIG. 7, since the first to fourth dummy read commands B0:dmyR1 to B0:dmyR4 should be performed, a turnaround at time b may not be needed. Thus, the first to fourth dummy read commands B0:dmyR1 to B0:dmyR4 added to the scheduling queue may be sequentially performed from time b to time c. The inter-command interval of the first to fourth dummy read commands B0:dmyR1 to B0:dmyR4 may be tCCD. When the processing of the first to fourth read commands B0:R1 to B0:R4 and the first to fourth dummy read commands B0:dmyR1 to B0:dmyR4 is completed at time c, the turnaround time TRN may be performed to change to the write phase in order to perform the first to fourth normal write commands B0:W1 to B0:W4.

According to an embodiment, the first to fourth normal write commands B0:W1 to B0:W4 may be sequentially performed during time d to time e. Referring also to FIG. 5B, it may be apparent that the write data written through the normal write command may be the data obtained by merging the mask region of the read data corresponding to the first to fourth dummy read commands B0:dmyR1 to B0:dmyR4 with the first to fourth masked write data MWR(4). In comparison to the comparative example in FIG. 7, the embodiment described with reference to FIG. 8 may enable faster processing of the masked write commands by converting the masked write commands into both the dummy read command and the normal write command and processing them. For example, when the masked write command is processed, according to a related memory controller, the delay tCCDMW may be relatively long (e.g., tCCDMW=4×tCCD). However, when the masked write command is processed as described with reference to FIG. 7, the delay tCCDMW may be comparatively shorter (e.g., tCCDMW=2×tCCD), which may be equal to the sum of the processing times of a dummy read command (e.g., one of the first to fourth dummy read commands B0:dmyR1 to B0:dmyR4) and a normal write command (e.g., one of the first to fourth normal write commands B0:W1 to B0:W4).

According to an embodiment, when the masked write request and the read request targeting different regions of the same page are repeatedly processed as shown in FIG. 8, the reduction effect of the processing time may be represented as an equation similar to Equation 1.

$$\frac{( {N}_{R E A D} \times tCCD ) + ( {N}_{M W C} \times tCCD \times 2 )}{( {N}_{R E A D} \times tCCD ) + ( {N}_{M W C} \times tCCD \times 4 )} [ \% ] \qquad [ Equation 1 ]$$

Referring to Equation 1, N_{READ} may represent the number of read commands, and N_{MWC} may represent the number of masked write commands, and tCCD may represent the command-to-command delay. If the number of requests is sufficiently large, delays caused by DRAM scheduling, such as, but not limited to, activate, pre-charge, refresh time, and bus turnaround time, may be reduced and/or diminished and may eventually converge to the rate given by Equation 1.

Referring to FIG. 8, according to an embodiment, it may be observed that the processing of the eight (8) commands may be completed up to 5×tCCD faster, when compared to the elapsed time processing the eight (8) commands of FIG. 7, by converting the first to fourth masked write commands B0:MWR1 to B0:MWR4 into the first to fourth dummy read commands B0:R1 to B0:R4 and the first to fourth normal write commands B0:W1 to B0:W4. Compared to FIG. 7, it may be apparent that the process may be completed 9×tCCD faster (e.g., 3×(3×tCCD)) due to the removal of three (3) bubble sections (e.g., each bubble section having a time duration of 3×tCCD). However, since 4×tCCD is consumed by additionally executing four (4) dummy read commands, it may be apparent that the process may ultimately be completed 5×tCCD faster (e.g., 9×tCCD−4×tCCD=5×tCCD). However, embodiments of the present disclosure are not limited to this example, and other time savings may be reached depending on the number of read commands and the number of masked write commands as described above with reference to Equation 1.

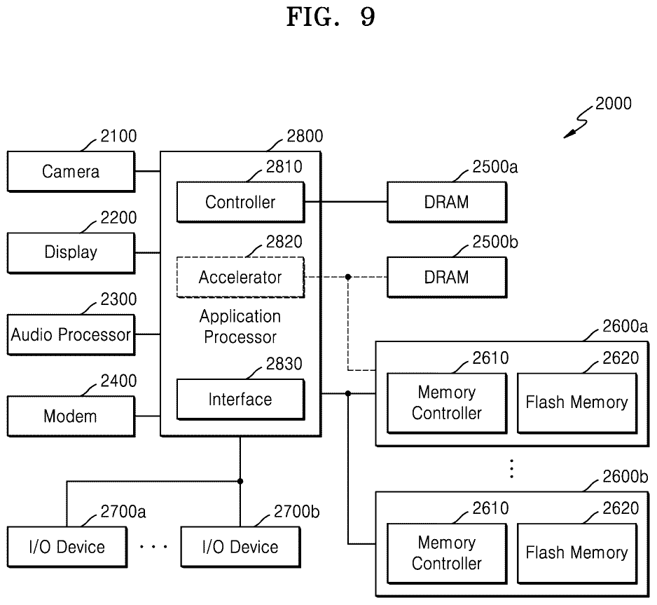

FIG. 9 is a block diagram of a system 2000 with an electronic device including the memory device, according to an embodiment.

Referring to FIG. 9, the system 2000 may include a camera 2100, a display 2200, an audio processor 2300, a modem 2400, a plurality of dynamic random access memories (DRAMs) (e.g., a first DRAM 2500a and a second DRAM 2500b), a plurality of flash memory devices (e.g., a first flash memory device 2600a and a second flash memory device 2600b), a plurality of input/output (I/O) devices (e.g., a first I/O device 2700a and a second I/O device 2700b), and an application processor (AP) 2800. The system 2000 may be implemented as a laptop computer, a mobile phone, a smartphone, a tablet personal computer, a wearable device, a healthcare device, an Internet of Things (IoT) device, or the like. Additionally or alternatively, the system 2000 may be implemented as a server or a personal computer. However, embodiments of the present disclosure are not limited thereto, and the system 2000 may be implemented as other electronic devices. Notably, the system 2000 may be implemented by any electronic device that includes a memory controller 100 as described above with reference to FIGS. 1 to 8.

The camera 2100 may capture still and/or moving images under user control and either store the captured images or transmit the captured images to the display 2200. The audio processor 2300 may process audio data included in contents of the plurality of flash memory devices 2600a to 2600b and/or a network. The modem 2400 may perform wired and/or wireless data transmission and/or reception, where a transmitting component may modulate and transmit signals, and a receiving component may perform demodulation to recover original signals from received signals. The plurality of I/O devices 2700a to 2700b may include I/O devices providing digital input and/or output capabilities, such as, but not limited to, a universal serial bus (USB), storage, a digital camera, a secure digital (SD) card, a digital versatile disc (DVD), a network adapter, a touch screen, or the like.

The AP 2800 may control the overall operation of the system 2000. The AP 2800 may include a controller block 2810, an accelerator block or accelerator chip 2820, and an interface block 2830. The AP 2800 may control the display 2200 so that a portion of the contents stored in the plurality of flash memory devices 2600a to 2600b may be displayed on the display 2200. When a user input is received through the plurality of I/O devices 2700a to 2700b, the AP 2800 may perform a control operation corresponding to the user input. The AP 2800 may include an accelerator block 2820, which may be and/or may include a dedicated circuit for artificial intelligence (AI) data processing, and/or may have the accelerator chip 2820 separately from the AP 2800. Additionally, the DRAM 2500b may be mounted on the accelerator block or accelerator chip 2820. The accelerator block 2820 may be and/or may include a functional block that may specialize in performing a specific function of the AP 2800. For example, the accelerator block 2820 may be and/or may include a graphics processing unit (GPU), which may be a processing block that may specialize in performing graphics data processing data, a neural processing unit (NPU), which may be a processing block that may specialize in performing AI calculations and inference, a data processing unit (DPU), which may be a processing block that may specialize in data transmission, or the like.

The system 2000 may include the plurality of DRAMs 2500a to 2500b. The AP 2800 may control the plurality of DRAMs 2500a to 2500b using commands and/or mode register (MRS) settings that may comply with one or more memory module standards, such as, but not limited to, Joint Electron Device Engineering Council (JEDEC) standard specifications. Alternatively or additionally, the AP 2800 may communicate with the plurality of DRAMs 2500a to 2500b by configuring a DRAM interface protocol to utilize proprietary features, such as, but not limited to, low voltage operation, high-speed processing, enhanced reliability, and/or data integrity mechanisms (e.g., cyclic redundancy check (CRC) and ECC). For example, the AP 2800 may communicate with the first DRAM 2500a through an interface that may conform to one or more JEDEC standard specifications, such as, but not limited to, low power double data rate 4 (LPDDR4) and low power double data rate 5 (LPDDR5). As another example, the accelerator block or accelerator chip 2820 may communicate with the first DRAM 2500a by configuring a new DRAM interface specification to control the second DRAM 2500b for the accelerator block 2820 that may support a higher bandwidth (e.g., transfer speed) than the first DRAM 2500a.

Although FIG. 9 illustrates two DRAMs (e.g., the first DRAM 2500a and the second DRAM 2500b), embodiments of the present disclosure are not limited thereto, and for example, the plurality of DRAMs may include additional memory devices. That is, the plurality of DRAM devices may include any memory type, such as, but not limited to, phase-change random access memory (PRAM), static random access memory (SRAM), magneto-resistive random access memory (MRAM), resistive random access memory (RRAM), ferroelectric random access memory (FRAM), or hybrid random access memory (RAM). Notably, any memory type may be used as long as the memory device satisfies a bandwidth, a response speed, and/or voltage conditions of the AP 2800 or the accelerator chip 2820. The plurality of DRAMs 2500a to 2500b may have relatively lower latency and/or bandwidth when compared to the plurality of I/O devices 2700a to 2700b and/or the plurality of flash memory devices 2600a to 2600b. The plurality of DRAMs 2500a to 2500b may be initialized when the system 2000 is powered on, and an operating system and/or application data may be loaded, providing for the plurality of DRAMs 2500a to 2500b to be used as temporary storage for the operating system and/or application data and/or as execution spaces for various software code.

Within the plurality of DRAMs 2500a to 2500b, arithmetic operations such as, but not limited to, addition, subtraction, multiplication, and division, as well as vector operations, address operations, and Fast Fourier Transform (FFT) operations, may be performed. Additionally, a function for performing inference may be executed within the plurality of DRAMs 2500a to 2500b. As used herein, the inference may be performed using a deep learning algorithm with an artificial neural network. The deep learning algorithm may include a training step in which a model may be learned from various data, and an inference step in which data may be recognized using the learned model. In an embodiment, an image captured by a user through the camera 2100 may be signal-processed and stored in the DRAM 2500b, and the accelerator block or accelerator chip 2820 may perform AI data operations to recognize data by using the data stored in the second DRAM 2500b and a function may be used for inference.

The system 2000 may include a plurality of storages and/or the plurality of flash memory devices 2600a to 2600b, which may have a larger capacity than the plurality of DRAMs 2500a to 2500b. The accelerator block or accelerator chip 2820 may perform training steps and AI data operations using the plurality of flash memory devices 2600a to 2600b. In an embodiment, each of the plurality of flash memory devices 2600a to 2600b may include a memory controller 2610 and a flash memory device 2620, and may more efficiently perform the training step and inference AI data operations performed by the AP 2800 and/or the accelerator chip 2820, by using the computational device provided in the memory controller 2610. The plurality of flash memory devices 2600a to 2600b may store pictures captured by the camera 2100 and/or data transmitted through a data network. For example, augmented reality (AR)/virtual reality (VR), high definition (HD), and/or ultra high definition (UHD) content may be stored.

In the system 2000, the plurality of DRAMs 2500a to 2500b may perform the method of processing the masked write command described with reference to FIGS. 1 to 8. The method of processing the masked command may include the operations of receiving the masked write request from the host, generating the dummy read command for a target address of the masked write request in response to the masked write request, converting the masked write request into the normal write command in response to processing the dummy read command, and performing the normal write command.

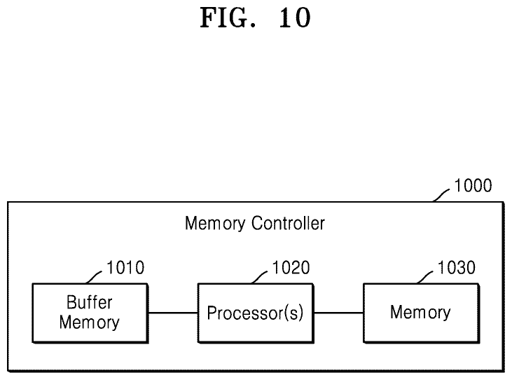

FIG. 10 is a block diagram of a memory controller 1000, according to embodiments.

Referring FIG. 10, a memory controller 1000 comprises a buffer memory 1010, one or more processors 1020 comprising processing circuitry and a memory 1030 storing instructions. According to an embodiment, the instructions, when executed by the one or more processors individually or collectively, cause the memory controller 1000 to receive, from a host, a masked write request; generate a dummy read command for a target address of the masked write request; and convert the masked write request into a normal write command, based on processing of the dummy read command. According to an embodiment, the memory controller 1000 may perform the method of processing the masked write command described with reference to FIGS. 1 to 8.

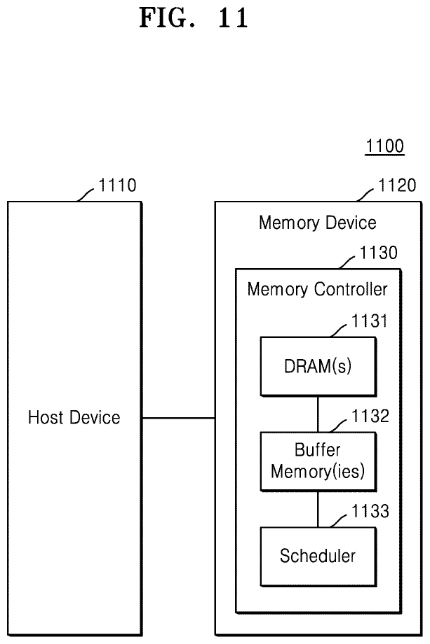

FIG. 11 is a block diagram of a memory system 1100, according to embodiments.

Referring FIG. 11, a memory system 1100 comprises a host device 1110 configured to generate a masked write request comprising masked write data and mask bits indicating a mask region; and a memory device 1120 comprising a memory controller 1130 comprising one or more dynamic random access memories (DRAMs) 1131, one or more buffer memories 1132, and a scheduler 1133. According to an embodiment, the memory controller 1130 may be configured to receive, from the host device 1110, the masked write request, generate a dummy read command for a target address of the masked write request, and convert the masked write request into a normal write command, based on processing of the dummy read command. According to an embodiment, the memory controller 1130 may perform the method of processing the masked write command described with reference to FIGS. 1 to 8.

While the present disclosure has been particularly shown and described with reference to embodiments thereof, it is to be understood that various changes in form and details may be made therein without departing from the spirit and scope of the following claims.

What is claimed is:

1. An operating method of a memory controller, the operating method comprising:
receiving, from a host, a masked write request;
generating a dummy read command for a target address of the masked write request;
converting the masked write request into a normal write command, based on processing of the dummy read command; and
performing the normal write command.

2. The operating method of claim 1, further comprising:
requesting allocation of a buffer region in a buffer, based on the receiving of the masked write request the buffer region having a size corresponding to a data bandwidth; and
writing, to a non-masked area of the buffer region, first data corresponding to masked write data of the masked write request.

3. The operating method of claim 2, wherein the converting of the masked write request comprises:
determining whether a page hit of the target address has occurred, based on a page table entry.

4. The operating method of claim 3, wherein the converting of the masked write request further comprises:
obtaining, based on determining that the page hit has occurred, read data by performing the dummy read command on the target address; and
writing, to a masked area of the buffer region, second data of the read data corresponding to the masked area.

5. The operating method of claim 4, wherein the performing of the normal write command comprises:
writing, to the target address, the first data and the second data stored in the buffer region.

6. The operating method of claim 5, further comprising:
deallocating and flushing the buffer region, based on the writing of the first data and the second data being completed.

7. The operating method of claim 1, wherein a priority of the dummy read command is lower than a priority of a normal read command.

8. A memory controller, comprising:
a buffer memory;
one or more processors comprising processing circuitry; and
memory storing instructions,
wherein the instructions, when executed by the one or more processors individually or collectively, cause the memory controller to:
receive, from a host, a masked write request;
generate a dummy read command for a target address of the masked write request; and
convert the masked write request into a normal write command, based on processing of the dummy read command.

9. The memory controller of claim 8, wherein the instructions, when executed by the one or more processors individually or collectively, further cause the memory controller to:
based on the received the masked write request, request allocation of a buffer region in the buffer memory, the buffer region having a size corresponding to a data bandwidth; and
write, to a non-mask region of the buffer region, first data corresponding to masked write data of the masked write request.

10. The memory controller of claim 9, wherein the instructions, when executed by the one or more processors individually or collectively, further cause the memory controller to:
determine whether a page hit of the target address has occurred, based on a page table entry.

11. The memory controller of claim 10, wherein the instructions, when executed by the one or more processors individually or collectively, further cause the memory controller to:
based on a determination that the page hit has occurred, obtain read data by performing the dummy read command on the target address; and
write, to a masked area of the buffer region, second data of the read data corresponding to the masked area.

12. The memory controller of claim 11, wherein the instructions, when executed by the one or more processors individually or collectively, further cause the memory controller to:
write, to the target address, the first data and the second data stored in the buffer region.

13. The memory controller of claim 12, wherein the instructions, when executed by the one or more processors individually or collectively, further cause the memory controller to:
deallocate and flush the buffer region, based on the writing of the first data and the second data being completed.

14. The memory controller of claim 8, wherein a priority of the dummy read command is lower than a priority of a normal read command.

15. A memory system, comprising:
a host device configured to generate a masked write request comprising masked write data and mask bits indicating a mask region; and
a memory device comprising a memory controller comprising one or more dynamic random access memories (DRAMs), one or more buffer memories, and a scheduler,
wherein the memory controller is configured to:
receive, from the host device, the masked write request,
generate a dummy read command for a target address of the masked write request, and
convert the masked write request into a normal write command, based on processing of the dummy read command.

16. The memory system of claim 15, wherein the memory controller is further configured to:
based on the received masked write request, request allocation of a buffer region in the one or more buffer memories, the buffer region having a size corresponding to a data bandwidth, and
write, to a non-mask region of the buffer region, first data corresponding to the masked write data of the masked write request.

17. The memory system of claim 16, wherein the scheduler is configured to:
determine whether a page hit of the target address has occurred based on a page table entry,
obtain read data by performing the dummy read command on the target address, based on a determination that the page hit has occurred, and
write, to a masked area of the buffer region, second data of the read data corresponding to the masked area.

18. The memory system of claim 17, wherein the memory controller is further configured to:
write, to the target address, the first data and the second data stored in the buffer region.

19. The memory system of claim 18, wherein the memory controller is further configured to:
deallocate and flush the buffer region, based on the writing of the first data and the second data being completed.

20. The memory system of claim 15, wherein a priority of the dummy read command is lower than a priority of a normal read command.
